(19) United States
(12) Patent Application Publication
(10) Pub. No.: US 2026/0282056 A1
(43) Pub. Date: Sep. 17, 2026

(54) TERMINAL DEVICE AND METHOD FOR SIDELINK RESOURCE SELECTION

(71) Applicant: LENOVO (BEIJING) LIMITED, Beijing (CN)

(72) Inventors: Jing Han, Beijing (CN); Ran Yue, Beijing (CN); Min Xu, Beijing (CN); Haiming Wang, Beijing (CN); Xiaodong Yu, Beijing (CN)

(21) Appl. No.: 19/470,966

(22) PCT Filed: Mar. 30, 2023
(86) PCT No.: PCT/CN2023/085204

§ 371 Date: Sep. 30, 2025

(51) Int. Cl. H04W 72/40; H04W 74/0808

(52) U.S. Cl. CPC H04W 72/40; H04W 74/0808

(57) ABSTRACT

Embodiments of the present disclosure relate to a terminal device and a method for sidelink resource selection. A terminal device triggers a sidelink resource selection for a sidelink transmission in an unlicensed band, wherein a listen before talk (LBT) procedure is to be performed prior to the sidelink transmission. The terminal device performs the sidelink resource selection based on a condition associated with at least one resource reserved by the terminal device. In this way, impacts from/to the reserved resources of terminal device itself may be avoided in resource selection for a sidelink transmission.

### FIELD

Embodiments of the present disclosure generally relate to the field of communication, and in particular to a terminal device, a method, and a non-transitory computer readable medium for sidelink resource selection.

### BACKGROUND

The New Radio (NR) operation on unlicensed bands relies on the user equipment (UE) sensing selected radio resources before commencing transmission. This technique is known as Listen-Before-Talk (LBT). In NR on Unlicensed band (NR-U), to co-exist with other wireless technology on unlicensed band e.g. Wi-Fi system, a LBT procedure may be performed on a selected resource before each transmission to occupy the channel. If LBT is failed, which means the channel is already occupied, corresponding transmission will be dropped.

Sidelink (SL) transmissions may also operate on unlicensed bands. The LBT technique in NR-U may be introduced for the SL transmission to co-exist with other wireless systems on the unlicensed bands. Enhancements on resource selection for SL on Unlicensed band (SL-U) are still needed.

### SUMMARY

In general, embodiments of the present disclosure provide a solution for resource selection in an unlicensed band for a sidelink transmission.

In a first aspect, there is provided a terminal device. The terminal device comprises a processor and a transceiver coupled to the processor. The processor is configured to trigger a resource selection for a sidelink transmission in an unlicensed band, wherein a listen before talk (LBT) procedure is to be performed prior to the sidelink transmission; and perform the resource selection based on a condition associated with at least one resource reserved by the terminal device.

In a second aspect, there is provided a terminal device. The terminal device comprises a processor and a transceiver coupled to the processor. The processor is configured to reselect at least one slot in an unlicensed band in the case that a listen before talk (LBT) procedure fails for a multi-consecutive slots transmission (MCSt) comprising one or more transmissions of a medium access control protocol data unit (MAC PDU); and retransmit at least one of one or more transmissions in the at least one slot.

In a third aspect, there is provided a method performed by a terminal device. The method comprises triggering a sidelink resource selection for a sidelink transmission in an unlicensed band, wherein a listen before talk (LBT) procedure is to be performed prior to the sidelink transmission. The method further comprises performing the sidelink resource selection based on a condition associated with at least one resource reserved by the terminal device.

In a fourth aspect, there is provided a method performed by a terminal device. The method comprises reselecting at least one slot in an unlicensed band in the case that a listen before talk (LBT) procedure fails for a multi-consecutive slots transmission (MCSt) comprising one or more transmissions of a medium access control protocol data unit (MAC PDU). The method further comprises retransmitting at least one of one or more transmissions in the at least one slot.

In a fifth aspect, there is provided a non-transitory computer readable medium. The non-transitory computer readable medium having program instructions stored thereon. The program instructions, when executed by an apparatus, causing the apparatus at least to: trigger a resource selection for a sidelink transmission in an unlicensed band, wherein a listen before talk (LBT) procedure is to be performed prior to the sidelink transmission; and perform the resource selection based on a condition associated with at least one resource reserved by the terminal device.

In a sixth aspect, there is provided a non-transitory computer readable medium. The non-transitory computer readable medium having program instructions stored thereon. The program instructions, when executed by an apparatus, causing the apparatus at least to: reselect at least one slot in an unlicensed band in the case that a listen before talk (LBT) procedure fails for a multi-consecutive slots transmission (MCSt) comprising one or more transmissions of a medium access control protocol data unit (MAC PDU); and retransmit at least one of one or more transmissions in the at least one slot.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some embodiments will now be described with reference to the accompanying drawings, in which:

FIG. 1 illustrates a schematic diagram of a communication environment in which some embodiments of the present disclosure can be implemented;

FIG. 2 illustrates a flowchart of an example method for resource selection in accordance with some embodiments of the present disclosure;

FIGS. 3A-3D illustrate examples of resource distributions for a resource selection in accordance with some embodiments of the present disclosure;

FIG. 4 illustrates a flowchart of an example method for resource selection in accordance with some embodiments of the present disclosure;

FIGS. 5A-5B illustrate examples of resource (re) selections for a MCSt transmission in accordance with some embodiments of the present disclosure; and

FIG. 6 illustrates a simplified block diagram of an apparatus that is suitable for implementing embodiments of the present disclosure.

Throughout the drawings, the same or similar reference numerals represent the same or similar elements.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” “some embodiments,” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s). Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, the term “communication network” refers to a network following any suitable communication standards, such as, 5G NR, Long Term Evolution (LTE), LTE-Advanced (LTE-A), Wideband Code Division Multiple Access (WCDMA), High-Speed Packet Access (HSPA), Narrow Band Internet of Things (NB-IOT), and so on. Further, the communications between a terminal device and a network device in the communication network may be performed according to any suitable generation communication protocols, including but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will also be future type communication technologies and systems in which the present disclosure may be embodied. It should not be seen as limiting the scope of the present disclosure to only the aforementioned systems.

As used herein, the term “network device” generally refers to a node in a communication network via which a terminal device can access the communication network and receive services therefrom. The network device may refer to a base station (BS) or an access point (AP), for example, a node B (NodeB or NB), a radio access network (RAN) node, an evolved NodeB (eNodeB or eNB), a NR NB (also referred to as a gNB), a Remote Radio Unit (RRU), a radio header (RH), an infrastructure device for a V2X (vehicle-to-everything) communication, a transmission and reception point (TRP), a reception point (RP), a remote radio head (RRH), a relay, an integrated access and backhaul (IAB) node, a low power node such as a femto BS, a pico BS, and so forth, depending on the applied terminology and technology.

As used herein, the term “terminal device” generally refers to any end device that may be capable of wireless communications. By way of example rather than a limitation, a terminal device may also be referred to as a communication device, a user equipment (UE), an end user device, a subscriber station (SS), an unmanned aerial vehicle (UAV), a portable subscriber station, a mobile station (MS), or an access terminal (AT). The terminal device may include, but is not limited to, a mobile phone, a cellular phone, a smart phone, a voice over IP (VOIP) phone, a wireless local loop phone, a tablet, a wearable terminal device, a personal digital assistant (PDA), a portable computer, a desktop computer, an image capture terminal device such as a digital camera, a gaming terminal device, a music storage and playback appliance, a vehicle-mounted wireless terminal device, a wireless endpoint, a mobile station, laptop-embedded equipment (LEE), laptop-mounted equipment (LME), a USB dongle, a smart device, wireless customer-premises equipment (CPE), an Internet of Things (IoT) device, a watch or other wearable, a head-mounted display (HMD), a vehicle, a drone, a medical device (for example, a remote surgery device), an industrial device (for example, a robot and/or other wireless devices operating in an industrial and/or an automated processing chain contexts), a consumer electronics device, a device operating on commercial and/or industrial wireless networks, and the like. In the following description, the terms: “terminal device,” “communication device,” “terminal,” “user equipment” and “UE,” may be used interchangeably.

As used herein, the term: “resource,” “transmission resource,” “resource block,” “physical resource block,” “uplink resource,” “downlink resource,” or “sidelink resource” may refer to any resource, for example a resource in time domain, a resource in frequency domain, a resource in space domain, a resource in code domain, or any other resource enabling a communication, and the like, used for performing a communication between a terminal device and a network device or between terminal devices. In the following, a resource in both frequency and time domain will be used as an example of a transmission resource for describing some embodiments of the present disclosure. It is noted that embodiments of the present disclosure equally apply to other resources in other domains.

To expand the applicability of sidelink resource selection to commercial use cases, one of identified key requirement is to increase the data rate. SL-U may be supported to fulfill the requirement. In addition, with the support of unlicensed spectrum, sidelink resource selection will be in a better position to be implemented in commercial devices since utilization of the Intelligent Transport System (ITS) band is limited to ITS safety related applications.

For study of sidelink over unlicensed band, one objective is the channel access mechanism, which is as following:

| - | Channel access mechanisms from NR-U shall be reused for sidelink unlicensed | |
|---|---|---|
| | operation | |
| | - | Assess the applicability of sidelink resource reservation from Rel-16/Rel-17 to |
| | | sidelink unlicensed operation within the boundaries of unlicensed channel |
| | | access mechanism and operation |

| | |
|---|---|
| - | No specific enhancements for Rel-17 resource allocation mechanisms |
| - | If the existing NR-U channel access framework does not support the |
| | required SL-U functionality, WGs will make appropriate |
| | recommendations for RAN approval. |

It has been agreed in TS 38.321 of the 3GPP standardization as follows:

Agreements on SL resource (re)selection

| | |
|---|---|
| 1: | RAN2 understands UE triggers a resource (re)selection when PSSCH |
| | transmission was not performed due to an LBT failure indication from L1. FFS |
| | on MCST case. Send LS to RAN1 to check if there is any concern. |
| 2a: | RAN2 understands L1 handles LBT impact to/from other UEs' reserved |
| | resources in SL candidate resource selection (inter-UE case). |
| 2b: | RAN2 will study how MAC performs resource (re)selection with the |
| | consideration of LBT impact to its own candidate resource (intra-UE case). |
| 3: | Will send LS to RAN1 to check if there is any concern. |

As mentioned above, the LBT mechanism in NR-U may be introduced for the SL transmission to co-exist with other wireless systems on unlicensed band. Before each sidelink transmission, SL UE may need to perform LBT and drop the sidelink transmission if the LBT is failed. A LBT failure is usually caused by inter-Radio Access Technology (inter-RAT) transmission, e.g. transmission of WiFi, NR-U, licensed-assisted access (LAA) etc. However, besides the inter-RAT impact, the intra-RAT impact for LBT failure also needs to be considered. For example, the selected radio resource in SL-U should not be impacted by or should not impact the reserved resource in SL-U. There are two sub-cases for intra-RAT transmission impact. One sub-case is for an inter-UE case, i.e., the impact from/to the resources reserved by other terminal devices, and may be handled by physical layer. The other sub-case is for an intra-UE case, i.e., the impact from/to the resources reserved by the SL UE itself. Enhancements on the SL-U regarding to the intra-UE case are needed.

In addition, it has been agreed in TS 38.321 of the 3GPP standardization as follows:

```
1. Resource (re)selection
For initial transmission
randomly select the time and frequency resources for one transmission opportunity from
the resources indicated by the physical layer as specified in clause 8.1.4 of TS 38.214 [7]
which occur within the SL DRX Active time if configured as specified in clause 5.28.2 of
the destination UE selected for indicating to the physical layer the SL DRX Active time
above, according to the amount of selected frequency resources and the remaining PDB of
SL data available in the logical channel(s) allowed on the carrier.
For retransmission
    5>if transmission based on full sensing or partial sensing is configured by upper
      layers and there are available resources left in the resources indicated by the
      physical layer according to clause 8.1.4 of TS 38.214 [7] for more transmission
      opportunities; or
    5>if transmission based on random selection is configured by upper layers and there
      are available resources left in the resource pool for more transmission
      opportunities:
        6>randomly select the time and frequency resources for one or more
          transmission opportunities from the available resources, according to the
          amount of selected frequency resources, the selected number of HARQ
          retransmissions and the remaining PDB of SL data available in the logical
          channel(s) allowed on the carrier by ensuring the minimum time gap
          between any two selected resources in case that PSFCH is configured for
          this pool of resources and that a retransmission resource can be indicated by
          the time resource assignment of a prior SCI according to clause 8.3.1.1 of
          TS 38.212 [9].
2. Resource (re)selection check
If the TX resource (re-)selection check procedure is triggered on the selected pool of
resources for a Sidelink process according to clause 5.22.1.1, the MAC entity shall for the
Sidelink process:
  1>if PSCCH duration(s) and 2nd stage SCI on PSSCH for all transmissions of a MAC
    PDU of any selected sidelink grant(s) are not in SL DRX Active time as specified in
    clause 5.28.3 of the destination that has data to be sent; or
  1>if SL_RESOURCE_RESELECTION_COUNTER = 0 and when
    SL_RESOURCE_RESELECTION_COUNTER was equal to 1 the MAC entity
    randomly selected, with equal probability, a value in the interval [0, 1] which is
    above the probability configured by RRC in sl-ProbResourceKeep; or
  1>if the pool of resources is configured or reconfigured by RRC; or
  1>if there is no selected sidelink grant on the selected pool of resources; or
  1>if neither transmission nor retransmission has been performed by the MAC entity on
    any resource indicated in the selected sidelink grant during the last second; or
  1>if sl-ReselectAfter is configured and the number of consecutive unused transmission
    opportunities on resources indicated in the selected sidelink grant, which is
    incremented by 1 when none of the resources of the selected sidelink grant within a
    resource reservation interval is used, is equal to sl-ReselectAfter; or
  1>if the selected sidelink grant cannot accommodate a RLC SDU by using the
    maximum allowed MCS configured by RRC in sl-MaxMCS-PSSCH associated with
    the selected MCS table and the UE selects not to segment the RLC SDU; or
  NOTE 1: If the selected sidelink grant cannot accommodate the RLC SDU, it is left for
        UE implementation whether to perform segmentation or sidelink resource
        reselection.
  1>if transmission(s) with the selected sidelink grant cannot fulfil the remaining PDB of
    the data in a logical channel, and the MAC entity selects not to perform
    transmission(s) corresponding to a single MAC PDU:
  NOTE 2: If the remaining PDB is not met, it is left for UE implementation whether to
        perform transmission(s) corresponding to single MAC PDU or sidelink
        resource reselection.
  NOTE 3: It is left for UE implementation whether to trigger the TX resource
        (re-)selection due to the latency requirement of the MAC CE triggered
        according to clause 5.22.1.7.
    2>clear the selected sidelink grant associated to the Sidelink process, if available;
    2>trigger the TX resource (re-)selection.
  NOTE 4: Void.
  NOTE 5: Void
```

It is still not clear how to trigger a resource (re) selection for a MCSt transmission. Details of a scheme for resource reselection for a MCSt transmission are incomplete and need to be developed.

Embodiments of the present disclosure provide a solution for resource selection in an unlicensed band for a sidelink transmission. Principles and implementations of embodiments of the present disclosure will be described in detail below with reference to the figures.

### Example Embodiment

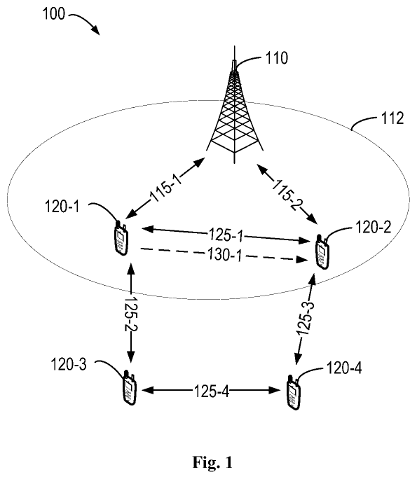

FIG. 1 illustrates a schematic diagram of a communication environment 100 in which some embodiments of the present disclosure can be implemented. As shown in FIG. 1, the communication environment 100, which may also be referred to as a communication network 100 or a communication system 100, includes a network device 110, a terminal device 120-1, a terminal device 120-2, a terminal device 120-3 and a terminal device 120-4 (collectively referred to as terminal devices 120).

The network device 110 manages a cell 112 and serves the terminal device 120-1 and the terminal device 120-2 in the cell 112. To transmit data and/or control information, the terminal device 120-1 and the terminal device 120-2 can perform communications with the network device 110, respectively. In particular, as illustrated in the exemplary scenario of FIG. 1, the terminal device 120-1 may communicate with the network device 110 via a communication link 115-1, and the terminal device 120-2 may communicate with the network device 110 via a communication channel 115-2. For transmissions from the network device 110 to the terminal device 120-1 or 120-2, the communication link 115-1 or 115-2 may be referred to as a downlink, whereas for transmissions from the terminal device 120-1 or 120-2 to the network device 110, the communication link 115-1 or 115-2 may alternatively be referred to as an uplink.

In addition to the communication links 115-1 and 115-2, the terminal device 120-1 and the terminal device 120-2 can perform a sidelink transmission, which is also referred to as a device-to-device (D2D) communication, via a sidelink 125-1 between the terminal device 120-1 and the terminal device 120-2. For example, in the exemplary scenario of FIG. 1, the terminal device 120-1 is to perform a sidelink transmission 130-1 to the terminal device 120-2 via the sidelink 125-1. In some embodiments, the sidelink transmission 130-1 may be performed on unlicensed band in which various wireless devices based on different wireless technologies share the same wireless spectrum.

As shown in FIG. 1, the terminal devices 120-3 and 120-4 may be outside of the coverage range (namely, outside of the cell 112) of the network device 110. For the terminal devices 120-3 and 120-4, only sidelink resource selections may exist. For example, the terminal device 120-1 and the terminal device 120-3 can perform a sidelink transmission via a sidelink 125-2 between the terminal device 120-1 and the terminal device 120-3. The terminal device 120-2 and the terminal device 120-4 can perform a sidelink transmission via a sidelink 125-3 between the terminal device 120-2 and the terminal device 120-4. The terminal device 120-3 and the terminal device 120-4 can perform a sidelink transmission via a sidelink 125-4 between the terminal device 120-3 and the terminal device 120-4. Although not shown in FIG. 1, sidelink transmissions may be performed between the terminal device 120-1 and the terminal device 120-4 and between the terminal device 120-2 and the terminal device 120-3 via respective sidelinks.

In some embodiments, the network device 110 may be absent in the communication environment 100. In other words, the terminal devices 120-1, 120-2, 120-3 and 120-4 as well as possibly other terminal devices (not shown) may be outside of the coverage range (namely, outside of the cell 112) of the network device 110. In such cases, only sidelink resource selections may exist between the terminal devices 120-1, 120-2, 120-3, 120-4 and possibly other terminal devices not shown in FIG. 1.

As used herein, the term “sidelink transmission” generally refers to any transmission performed from one terminal device to another terminal device. The sidelink transmission may be used for transmitting any data or control information associated with sidelink resource selections, for example, sidelink data, sidelink control information, sidelink feedback information, or the like. As used herein, the term “sidelink channel” may generally refer to any channel used for sidelink resource selections, for example, Physical Sidelink Shared Channel (PSSCH), Physical Sidelink Control Channel (PSCCH), Physical Sidelink Discovery Channel (PSDCH), Physical Sidelink Broadcast Channel (PSBCH), Physical Sidelink Feedback Channel (PSFCH), and other existing or future sidelink channels.

Channel access in the sidelink can rely on the so-called LBT procedure. For example, before performing the sidelink transmission 130-1, the terminal device 120-1 can firstly “sense” a communication channel to find out that there are no communications on the communication channel prior to any transmission on the communication channel. If the sidelink transmission 130-1 is to be performed in an unlicensed band, the terminal device 120-1 may first perform a sidelink resource selection for the sidelink transmission 130-1. If a sidelink resource is selected for the sidelink transmission 130-1, a LBT procedure may be performed prior to the sidelink transmission 130-1 on the selected sidelink resource. If the LBT is failed, the sidelink transmission 130-1 on the selected sidelink resource may be dropped and the terminal device 120-1 may perform a resource reselection procedure for another sidelink transmission 130-1.

Although the network device 110 and the terminal devices 120-1, 120-2, 120-3 and 120-4 are described in the communication environment 100 of FIG. 1, embodiments of the present disclosure may equally apply to any other suitable communication devices in communication with one another. That is, embodiments of the present disclosure are not limited to the exemplary scenarios of FIG. 1. In this regard, it is noted that although the network device 110 is schematically depicted as a base station and the terminal devices 120 are schematically depicted as mobile phones in FIG. 1, it is understood that these depictions are exemplary in nature without suggesting any limitation. In other embodiments, the network device 110 and the terminal devices 120 may be any other communication devices, for example, any other wireless communication devices.

In case the terminal devices 120-1, 120-2, 120-3 and 120-4 are vehicle-mounted terminal devices, communication relate to them may be referred to as a V2X communication. More generally, although not shown in FIG. 1, the V2X communication related to the terminal devices 120 may comprise a communication channel between the terminal devices 120 and any other communication device, including but not limited to, an infrastructure device, another vehicle-mounted terminal device, a device of a pedestrian, a roadside unit, or the like. Furthermore, although not shown, all the communication links as shown in FIG. 1 may be via one or more relays.

It is to be understood that the particular number of various communication devices, the particular number of various communication links, the particular number of other elements, and the particular shape of the cell 112 as shown in FIG. 1 is for illustration purpose only without suggesting any limitations. The communication environment 100 may include any suitable number of communication devices, any suitable number of communication links, any suitable number of other elements and any suitable shape of the cell 112 adapted for implementing embodiments of the present disclosure. In addition, it should be appreciated that there may be various wireless as well as wireline communications (if needed) among all of the communication devices.

Communication in the communication environment 100 may be implemented according to any proper communication protocol(s), comprising but not limited to, cellular communication protocols of the first generation (1G), the second generation (2G), the third generation (3G), the fourth generation (4G) and the fifth generation (5G), NR-U and the like, wireless local network communication protocols such as Institute for Electrical and Electronics Engineers (IEEE) 802.11 and the like, and/or any other protocols currently known or to be developed in the future. Moreover, such communication may utilize any appropriate wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

### Example Method

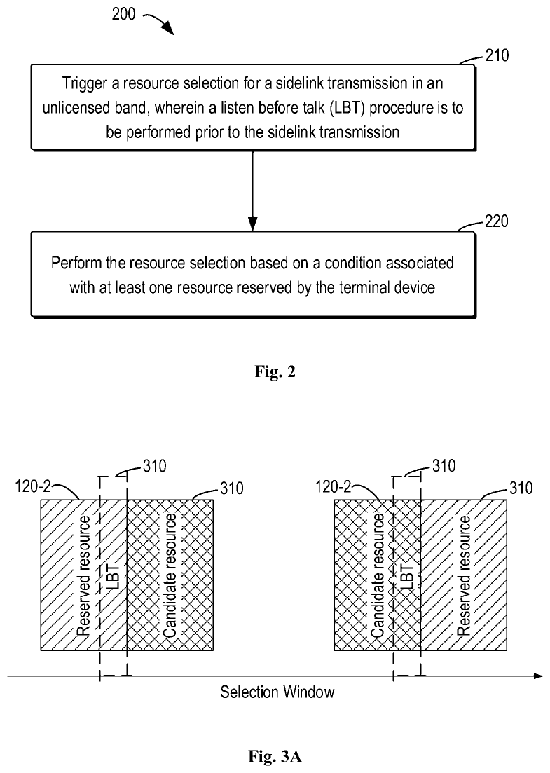

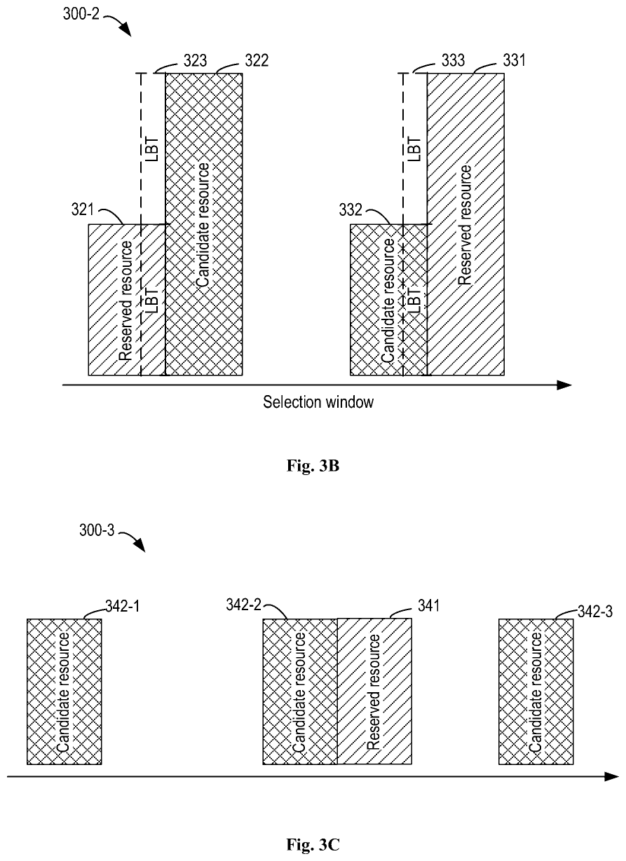

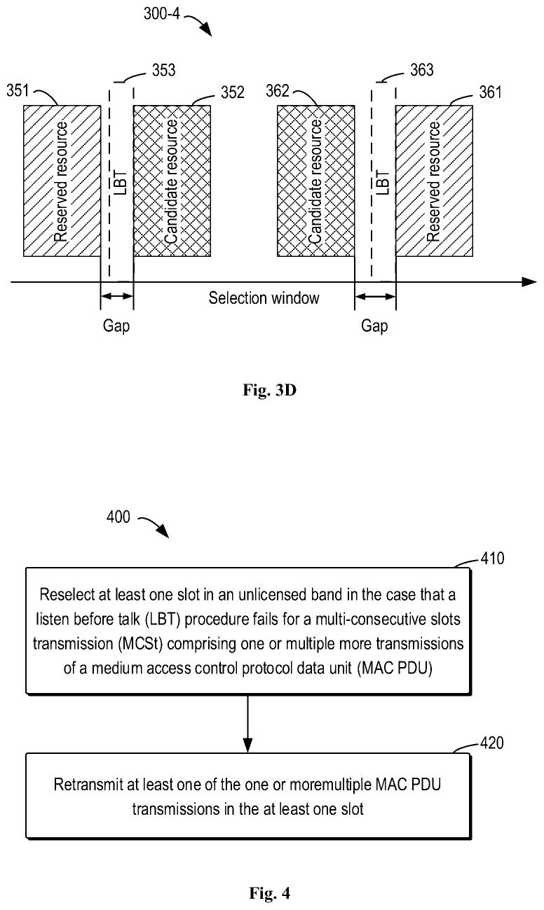

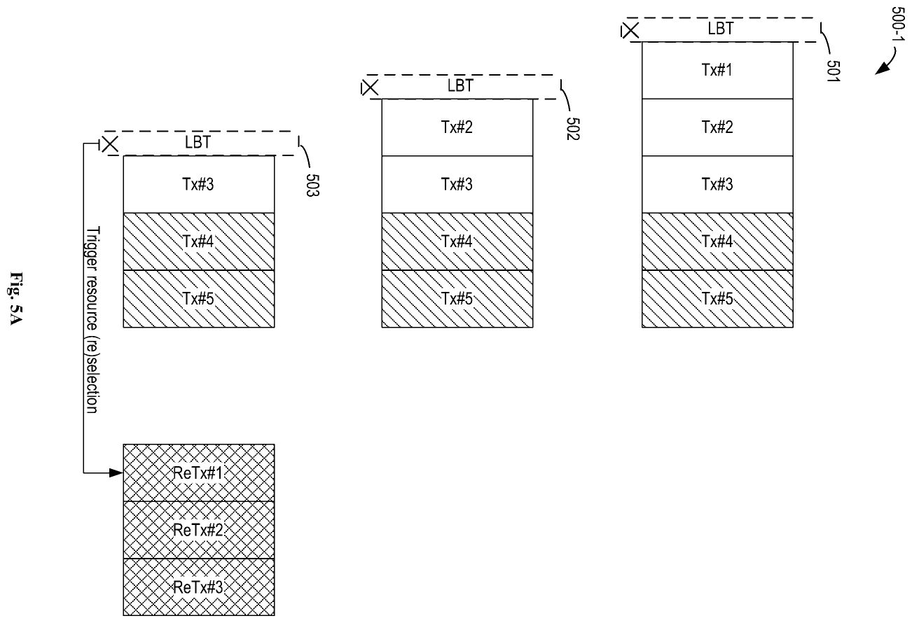

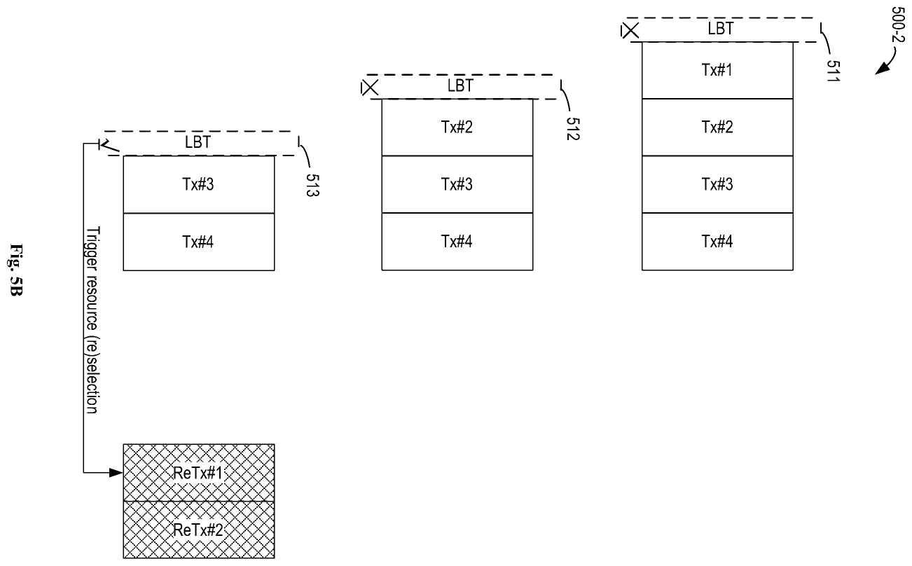

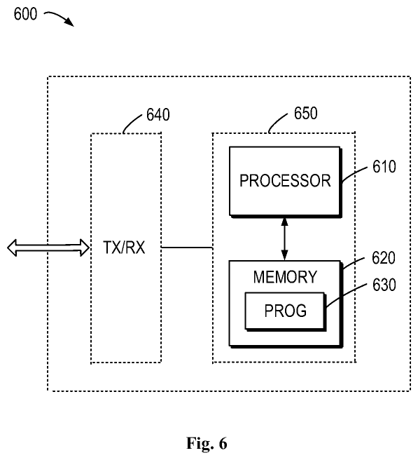

Hereinafter, some embodiments of resource selection for sidelink transmissions considering the impact from/to the resources reserved by the terminal device itself are described with reference to FIGS. 2-3D. Some embodiments of resource reselection for a MCSt transmission will be described with reference to FIGS. 4-5B.

FIG. 2 illustrates a flowchart of an example method 200 for resource selection in accordance with some embodiments of the present disclosure. In some embodiments, the method 200 can be implemented at a device in a communication network, such as the terminal device 120-1 as shown in FIG. 1. Additionally or alternatively, the method 200 can be implemented at other devices shown in FIG. 1. In some other embodiments, the method 200 may be implemented at devices not shown in FIG. 1. Further, it is to be understood that the method 200 may include additional blocks not shown and/or may omit some blocks as shown, and the scope of the present disclosure is not limited in this regard. For the purpose of discussion, the method 200 will be described from the perspective of the terminal device 120-1 with reference to FIG. 1.

At block 210, the terminal device 120-1 triggers a sidelink resource selection for a sidelink transmission in an unlicensed band. A LBT procedure is to be performed prior to the sidelink transmission. At block 220, the terminal device 120-1 performs the sidelink resource selection based on a condition associated with at least one resource reserved by the terminal device. For example, with reference to FIG. 1, the terminal device 120-1 may be in a UE-autonomous resource allocation mode (i.e., Mode 2). When a resource (re) selection trigger condition is fulfilled, e.g., upon traffic arrival or if there is buffered data ready for transmission in a logical channel, the terminal device 120-1 may perform a resource (re) selection procedure on available resources either from its physical layer or from the selected resource pool. In some embodiments, the terminal device 120-1 may have already reserved some resources e.g. for MAC PDU transmissions. In such events, the terminal device 120-1 may consider additional restrictions associated with the reserved resources when performing the sidelink resource selection. In this way, the impact from/to the resources reserved by the SL UE itself may be avoided in resource selection. Thus, the reliability and efficiency of sidelink communication may be improved and the transmission latency may be reduced.

Hereinafter, some embodiments of the sidelink resource selection scheme will be described in detail below with reference to FIGS. 3A-3D. FIGS. 3A-3D illustrate examples of resource distributions for a resource selection in accordance with some embodiments of the present disclosure. For the purpose of discussion, the resource distributions in FIGS. 3A-3D will be described with reference to FIGS. 1 and 2. The resource distributions in FIGS. 3A-3D are for illustration purpose only without suggesting any limitations. Other resource distributions are also possible.

FIG. 3A illustrates an example of a resource distribution 300-1 for a resource selection in accordance with some embodiments of the present disclosure. As described with reference to FIGS. 1 and 2, the terminal device 120-1 may implement the resource selection to select available resources on a channel of an unlicensed band for the sidelink transmission 130-1. For example, the terminal device 120-1 may have reserved one or more resources (e.g., reserved resources 301 and 311 in FIG. 3A), which may be used for additional packets or a re-transmission of a packet. In some embodiments, the terminal device 120-1 may identify candidate resources 302 and 312 from the available resources. A resource may correspond to, for example, one or more slots and one or more subchannels. Each subchannel may include one or more contiguous (or non-contiguous, e.g., interlaced) RBs. The resource distribution 300-1 is for illustration purpose only without suggesting any limitations. Other resource distributions are also possible. For example, although the reserved resource 301 and the candidate resource 302 are shown as consecutive resources in time domain and the candidate resource 311 and the reserved resource 312 are shown as consecutive resources in time domain, the candidate resources and the reserved resources may be inconsecutive resources in time domain.

In some embodiments, if a type-1 LBT duration related to a candidate resource is overlapped with one of the at least one reserved resource in time domain or if a type-1 LBT duration related to one of the at least one reserved resource is overlapped with the candidate resource in time domain, the terminal device 120-1 may avoid selecting the candidate resource for the sidelink transmission. For example, as shown in FIG. 3A, assuming the candidate resource 302 is selected for the sidelink transmission 130-1, the LBT duration 303 for the sidelink transmission 130-1 on the candidate resource 302 would be overlapped with the reserved resource 301. Assuming the candidate resource 312 is selected for the sidelink transmission 130-1, the LBT duration 313 for a transmission on the reserved resource 311 would be overlapped with the candidate resource 312. In some embodiments, terminal device 120-1 may avoid selecting or de-prioritized selecting the candidate resources 302 and 312 from the available resources.

In some embodiments, if the candidate resource and the reserved resource are consecutive resources in time domain but with different channel access priority class (CAPC) priorities for transmissions on the candidate resource and the reserved resource, the terminal device 120-1 may avoid selecting the candidate resource for the sidelink transmission. For example, as shown in FIG. 3A, the reserved resource 301 and the candidate resource 302 are consecutive resources in time domain and the candidate resource 311 and the reserved resource 312 are consecutive resources in time domain. In some embodiments, if a CAPC priority for a transmission on the reserved resource 301 is different from the CAPC priority for a transmission on the candidate resource 302, which means a higher one among the two CAPC priorities would be decreased if a LBT is performed for consecutive transmissions on the reserved resource 301 and the candidate resource 302. In such case, the terminal device 120-1 may avoid selecting or de-prioritized selecting the candidate resource 302 from the available resources. Similarly, if a CAPC priority for a transmission on the reserved resource 311 is different from the CAPC priority for a transmission on the candidate resource 312, terminal device 120-1 may avoid selecting or de-prioritized selecting the candidate resource 312 from the available resources.

In some embodiments, if the candidate resource and the reserved resource are consecutive resources in time domain but with different CAPC priorities for transmissions on the candidate resource and the reserved resource and a transmission priority for transmission on one of the consecutive resources with a higher CAPC priority is higher than a threshold priority, the terminal device 120-1 may avoid selecting the candidate resource for the sidelink transmission. For example, as shown in FIG. 3A, the reserved resource 301 and the candidate resource 302 are consecutive resources in time domain and a CAPC priority for a transmission on the reserved resource 301 may be higher than the CAPC priority for a transmission on the candidate resource 302. If the transmission priority for the transmission on the reserved resource 301 is higher than a threshold priority, the terminal device 120-1 may avoid selecting or de-prioritized selecting the candidate resource 302 for the sidelink transmission.

In some embodiments, the transmission priority may be a CAPC priority. In some embodiments, the transmission priority may be a traffic priority. In some embodiments, the transmission priority may be a (highest) logical channel priority. In some embodiments, the transmission priority may be a MAC PDU priority. In some embodiments, the threshold priority may be configured by a radio resource control (RRC).

In some embodiments, if the candidate resource and the reserved resource are consecutive resources in time domain but with different CAPC priorities for transmissions on the candidate resource and the reserved resource and a transmission priority for transmission on one of the consecutive resources with a higher CAPC priority is configured such that a CAPC priority cannot be decreased for the transmission priority, the terminal device 120-1 may avoid selecting the candidate resource for the sidelink transmission. In some embodiments, the transmission priority may be a CAPC priority. In some embodiments, the transmission priority may be a traffic priority. In some embodiments, the transmission priority may be a (highest) logical channel priority. In some embodiments, the transmission priority may be a MAC PDU priority. For example, as shown in FIG. 3A, the reserved resource 301 and the candidate resource 302 are consecutive resources in time domain and a CAPC priority for a transmission on the reserved resource 301 may be higher than the CAPC priority for a transmission on the candidate resource 302. If the logical channel priorities for the transmission on the reserved resource 301 comprise #1, #2 and #3 and the terminal device 120-1 is configured that the CAPC priority associated with logical channel priorities #1 and #2 cannot be decreased, the terminal device 120-1 may avoid selecting or de-prioritized selecting the candidate resource 302 for the sidelink transmission.

In some embodiments, if the candidate resource is subsequent to the reserved resource and in an expected channel occupancy time (COT) duration related to the reserved resource, and a CAPC priority for transmission on the candidate resource is lower than that on the reserved resource, the terminal device 120-1 may avoid selecting the candidate resource for the sidelink transmission. In other words, even if the candidate resource is in the expected COT duration related to the reserved resource, the terminal device 120-1 may avoid selecting or de-prioritized selecting the candidate resource for the sidelink transmission if the CAPC priority of the transmission on the candidate resource doesn't fulfill the COT requirement initiated by reserved resource.

In some embodiments, if the reserved resource is subsequent to the candidate resource and in an expected COT duration related to the candidate resource, and a CAPC priority for transmission on the reserved resource is lower than that on the candidate resource, the terminal device 120-1 may avoid selecting the candidate resource for the sidelink transmission. In other words, even if the reserved resource is in the expected COT duration related to the candidate resource, the terminal device 120-1 may avoid selecting or de-prioritized selecting the candidate resource for the sidelink transmission if the CAPC priority of the transmission on the reserved resource doesn't fulfill the COT requirement initiated by candidate resource.

In some embodiments, if the sidelink transmission is a wideband transmission for which multiple LBT procedures are to be performed on multiple resource block (RB) sets in the candidate resource, and at least one of the multiple LBT procedures is overlapped with the at least one reserved resource, the terminal device 120-1 may avoid selecting the candidate resource for the sidelink transmission. In some embodiments, if a transmission on one of the at least one reserved resource is a wideband transmission for which multiple LBT procedures are to be performed on multiple RB sets in the reserved resource, and at least one of the multiple LBT procedures is overlapped with the candidate resource, the terminal device 120-1 may avoid selecting the candidate resource for the sidelink transmission. In other words, if the candidate resource or the reserved resource is for a wide band transmission, i.e. the transmission on the candidate resource or the reserved resource is across multiple RB sets, multiple LBTs may be performed for the wide band transmission, i.e. one LBT on each RB set. In this case, the terminal device 120-1 may check whether any one of the multiple LBTs for the wide band transmission on the candidate resource or the reserved resource is overlapped with the reserved resource or the candidate resource and determine to handle the candidate resource or the reserved resource. For example, the terminal device 120-1 may avoid selecting the resources if there is any one of the multiple LBTs for the wide band transmission on the candidate resource or the reserved resource is overlapped with the reserved resource or the candidate resource. In some embodiments, the terminal device 120-1 may adjust the candidate resource or the reserved resource to guarantee a sufficient gap length between the candidate resource and the reserved resource.

FIG. 3B illustrates an example of another resource distribution 300-2 for a resource selection in accordance with some embodiments of the present disclosure. In some embodiments, the sidelink transmission 130-1 may be a wide band transmission, i.e. a transmission across multiple RB sets. As shown in FIG. 3B, assuming the candidate resource 322 is selected for the sidelink transmission 130-1, then multiple LBTs 323 may be performed for the wide band transmission, i.e. one LBT on each RB set. In some embodiments, since one of the LBTs 323 for the transmission on the candidate resource 322 is overlapped with the reserved resource 321, the terminal device 120-1 may determine to avoid selecting the candidate resource 322 for the sidelink transmission 130-1. Similarly, in some embodiments, the transmission on the reserved resource 331 may be a wide band transmission, then multiple LBTs 333 may be performed for the wide band transmission. In some embodiments, since one of the LBTs 333 for the transmission on the reserved resource 331 is overlapped with the candidate resource 332, the terminal device 120-1 may determine to avoid selecting the candidate resource 332 for the sidelink transmission 130-1.

In some embodiments, if the sidelink transmission is included in multiple MAC PDU transmissions, and at least one candidate resource of a series of candidate resources is overlapped with a type-1 LBT duration related to the at least one reserved resource, the terminal device 120-1 may avoid selecting the series of candidate resources for the multiple MAC PDU transmissions. In some embodiments, if the sidelink transmission is included in multiple MAC PDU transmissions, and a type-1 LBT duration related to at least one candidate resource of a series of candidate resources is overlapped with the at least one reserved resource, the terminal device 120-1 may avoid selecting the series of candidate resources for the multiple MAC PDU transmissions. In other words, if a series of candidate resources are selected for multiple MAC PDU transmission and a type-1 LBT duration for one or more of the series of candidate resources is overlapped with a reserved resource in time domain, or if a type-1 LBT duration for transmission on a reserved resource is overlapped with one or more of the series of candidate resources in time domain, the terminal device 120-1 may avoid selecting the series of candidate resources.

FIG. 3C illustrates an example of a further resource distribution 300-3 for a resource selection in accordance with some embodiments of the present disclosure. In some embodiments, the sidelink transmission 130-1 may comprise multiple MAC PDU transmissions. As shown in FIG. 3C, assuming a series of candidate resources 342-1, 342-2 and 342-3 are selected for the multiple MAC PDU transmissions in the sidelink transmission 130-1, the type-1 LBT duration for a transmission on the reserved resource 341 would be overlapped with the candidate resource 342-2. In some embodiments, the terminal device 120-1 may determine to avoid selecting the series of candidate resources 342-1, 342-2 and 342-3 for the sidelink transmission 130-1.

In some embodiments, if the sidelink transmission is included in multiple MAC PDU transmissions, and a candidate resource among a series of candidate resources is overlapped with a type-1 LBT duration related to the at least one reserved resource, the terminal device 120-1 may avoid selecting the overlapped candidate resource among the series of candidate resources for the multiple MAC PDU transmissions. In some embodiments, if the sidelink transmission is included in multiple MAC PDU transmissions, and a type-1 LBT duration related to a candidate resource among a series of candidate resources is overlapped with at least one reserved resource, the terminal device 120-1 may avoid selecting the candidate resource with the overlapped type-1 LBT duration among the series of candidate resources for the multiple MAC PDU transmissions. In other words, the terminal device 120-1 may only handle problematic resources of a series candidate resources for multiple MAC PDU transmission. If a series of candidate resources are selected for multiple MAC PDU transmission and a type-1 LBT duration for one or more of the series of candidate resources is overlapped with a reserved resource in time domain, or if a type-1 LBT duration for transmission on a reserved resource is overlapped with one or more of the series of candidate resources in time domain, the terminal device 120-1 may handle the one or more of the series of candidate resources. For example, the terminal device 120-1 may avoid selecting the one or more of the series of candidate resources. In some embodiments, the terminal device 120-1 may adjust the one or more of the series of candidate resources to guarantee a sufficient gap length between one or more of a series of candidate resources and the reserved resources.

As shown in FIG. 3C, assuming a series of candidate resources 342-1, 342-2 and 342-3 are selected for the multiple MAC PDU transmissions in the sidelink transmission 130-1, the type-1 LBT duration for a transmission on the reserved resource 341 would be overlapped with the candidate resource 342-2. In some embodiments, the terminal device 120-1 may determine to avoid selecting the candidate resource 342-2. For example, the terminal device 120-1 may adjust the candidate resource 342-2 to guarantee a sufficient gap length between the candidate resource and the reserved resource.

In some embodiments, if a type-1 LBT duration related to a candidate resource is not overlapped with the at least one reserved resource in time domain, and the candidate resource is not overlapped with type-1 LBT durations related to the at least one reserved resource in time domain, the terminal device 120-1 may determine the candidate resource as selectable for the sidelink transmission. In other words, if there is no overlapping between a type-1 LBT duration for transmission on the candidate resource and the reserved resources and no overlapping between the candidate resource and a type-1 LBT duration for transmission on any one of reserved resources, the candidate resource may be considered as selectable for the sidelink transmission.

In some embodiments, if a type-2 LBT procedure is to be performed for transmission on the candidate resource which is subsequent to one of the at least one reserved resource in time domain, the terminal device 120-1 may determine the candidate resource as selectable for the sidelink transmission. In other words, if a type-2 LBT procedure is to be performed for transmission on the candidate resource, the candidate resource may be considered as selectable for the sidelink transmission even if the candidate resource is immediately behind a reserved resource. In some embodiments, if a type-2 LBT procedure is to be performed for transmission on one of the at least one reserved resource which is subsequent to the candidate resource in time domain, the terminal device 120-1 may determine the candidate resource as selectable for the sidelink transmission. In other words, if a type-2 LBT procedure is to be performed for transmission on a reserved resource immediately behind a candidate resource, the candidate resource may be considered as selectable for the sidelink transmission. In some embodiments, if a type-2 LBT is expected to be used for transmission on either a candidate resource or a reserved resource, available candidate resources are selectable with no impact from/to the resources reserved by the terminal device itself.

In some embodiments, a type-1 LBT duration related to a candidate resource may be overlapped with one of the at least one reserved resource in time domain or a type-1 LBT duration related to one of the at least one reserved resource is overlapped with the candidate resource in time domain. If the candidate resource and the reserved resource are consecutive resources in time domain, the terminal device 120-1 may determine the candidate resource as selectable for the sidelink transmission. Turning back to FIG. 3A, the reserved resource 301 and the candidate resource 302 are consecutive resources in time domain and the candidate resource 311 and the reserved resource 312 are consecutive resources in time domain. In some embodiments, if the candidate resource 302 is selected for the sidelink transmission 130-1, a LBT may be performed for consecutive transmission on the candidate resource 302 and the reserved resource 301. If the CAPC priority of sidelink transmissions on the candidate resource 302 and the CAPC priority of sidelink transmissions on the reserved resource 301 are different, the higher one among the two CAPC priorities may be decreased.

In some embodiments, a type-1 LBT duration related to a candidate resource may be overlapped with one of the at least one reserved resource in time domain or a type-1 LBT duration related to one of the at least one reserved resource is overlapped with the candidate resource in time domain. If the candidate resource and the reserved resource are consecutive resources in time domain but with the same CAPC priority for transmissions on the candidate resource and the reserved resource, the terminal device 120-1 may determine the candidate resource as selectable for the sidelink transmission.

In some embodiments, a type-1 LBT duration related to a candidate resource may be overlapped with one of the at least one reserved resource in time domain or a type-1 LBT duration related to one of the at least one reserved resource is overlapped with the candidate resource in time domain. If the candidate resource and the reserved resource are consecutive resources in time domain but with different CAPC priorities for transmissions on the candidate resource and the reserved resource, a transmission priority for transmission on one of the consecutive resources with a higher CAPC priority is lower than a threshold priority, the terminal device 120-1 may determine the candidate resource as selectable for the sidelink transmission. In some embodiments, the transmission priority may be a CAPC priority. In some embodiments, the transmission priority may be a traffic priority. In some embodiments, the transmission priority may be a (highest) logical channel priority. In some embodiments, the transmission priority may be a MAC PDU priority.

In some embodiments, a type-1 LBT duration related to a candidate resource may be overlapped with one of the at least one reserved resource in time domain or a type-1 LBT duration related to one of the at least one reserved resource is overlapped with the candidate resource in time domain. If the candidate resource and the reserved resource are consecutive resources in time domain but with different CAPC priorities for transmissions on the candidate resource and the reserved resource, and a transmission priority for transmission on one of the consecutive resources with a higher CAPC priority is configured such that a CAPC priority can be decreased for the transmission priority, the terminal device 120-1 may determine the candidate resource as selectable for the sidelink transmission. In some embodiments, the transmission priority may be a CAPC priority. In some embodiments, the transmission priority may be a traffic priority. In some embodiments, the transmission priority may be a (highest) logical channel priority. In some embodiments, the transmission priority may be a MAC PDU priority.

In some embodiments, a type-1 LBT duration related to a candidate resource may be overlapped with one of the at least one reserved resource in time domain or a type-1 LBT duration related to one of the at least one reserved resource is overlapped with the candidate resource in time domain. If the candidate resource is subsequent to the reserved resource and in an expected COT duration related to the reserved resource, and a CAPC priority for transmission on the candidate resource is higher than that on the reserved resource, the terminal device 120-1 may determine the candidate resource as selectable for the sidelink transmission.

In some embodiments, a type-1 LBT duration related to a candidate resource may be overlapped with one of the at least one reserved resource in time domain or a type-1 LBT duration related to one of the at least one reserved resource is overlapped with the candidate resource in time domain. If the reserved resource is subsequent to the candidate resource and in an expected COT duration related to the candidate resource, and a CAPC priority for transmission on the reserved resource is higher than that on the candidate resource, the terminal device 120-1 may determine the candidate resource as selectable for the sidelink transmission.

In some embodiments, a type-1 LBT duration related to a candidate resource may be overlapped with one of the at least one reserved resource in time domain or a type-1 LBT duration related to one of the at least one reserved resource is overlapped with the candidate resource in time domain. If the candidate resource is subsequent to the reserved resource and in a shared COT duration related to the reserved resource, and a transmission on the candidate resource fulfills a condition to utilize the shared COT duration, the terminal device 120-1 may determine the candidate resource as selectable for the sidelink transmission.

In some embodiments, a type-1 LBT duration related to a candidate resource may be overlapped with one of the at least one reserved resource in time domain or a type-1 LBT duration related to one of the at least one reserved resource is overlapped with the candidate resource in time domain. If the reserved resource is subsequent to the candidate resource and in in a shared COT duration for transmission on the candidate resource, and a transmission on the reserved resource fulfills a condition to utilize the shared COT duration, the terminal device 120-1 may determine the candidate resource as selectable for the sidelink transmission.

In some embodiments, the terminal device 120-1 may determine the candidate resource as selectable for the sidelink transmission if a gap length between the candidate resource and the at least one reserved resource is no smaller than a predetermined type-1 LBT duration length for transmission on the candidate resource or the at least one reserved resource. In some embodiments, the predetermined type-1 LBT duration length may be configured or preconfigured for a CAPC priority. In some embodiments, the predetermined type-1 LBT duration length may be specified by a standard for a CAPC priority. In some embodiments, the predetermined type-1 LBT duration length may be indicated by a physical layer of the terminal device for a CAPC priority.

In other words, the terminal device 120-1 may select the candidate resource from the available resources, and guarantee that there is enough gap length between the selected candidate resource and the reserved resources. The gap length may be equal or larger than the type-1 LBT duration for transmission on the candidate resource or the reserved resource. Since the type-1 LBT duration is a random duration, there is no accurate type-1 LBT duration before the transmission is to be performed. In some embodiments, a typical type-1 LBT duration length may be directly specified in standardization or (pre) configured for each CAPC priority. Then the terminal device 120-1 may determine the typical LBT duration according to the expected CAPC priority of transmission on the reserved resource or the candidate resource and the configured/specified association between CAPC priority and typical LBT duration length. Then the terminal device 120-1 may guarantee the gap based on this typical type-1 LBT duration. In some embodiments, the typical LBT duration of transmission on the candidate resource/reserved resource may be indicated from the physical layer of the terminal device, and then the MAC layer of the terminal device may guarantee the gap based on the indicated typical LBT duration. In some embodiments, the typical type-1 LBT duration can also be used by the terminal device 120-1 to determine whether a type-1 LBT duration related to a candidate resource is overlapped with one of the at least one reserved resource in time domain or whether a type-1 LBT duration related to one of the at least one reserved resource is overlapped with the candidate resource in time domain. The terminal device 120-1 may determine whether the candidate resource can be selected or not based on a comparison of the resource gap and the typical type-1 LBT duration as well as other optional conditions described above.

FIG. 3D illustrates an example of yet a further resource distribution 300-4 for a resource selection in accordance with some embodiments of the present disclosure. As shown in FIG. 3D, if the gap between the reserved resource 351 and the subsequent candidate resource 352 is equal to or larger than the typical type-1 LBT duration 353 corresponding to a CAPC priority for a transmission on the candidate resource 352, the candidate resource 352 may be considered as selectable for the sidelink transmission. Similarly, if the gap between the candidate resource 362 and the subsequent reserved resource 361 is equal to or larger than the typical type-1 LBT duration 363 corresponding to a CAPC priority for a transmission on the reserved resource 361, the candidate resource 362 may be considered as selectable for the sidelink transmission. In some embodiments, since the gap between the reserved resource 351 and the subsequent candidate resource 352 is equal to or larger than the typical type-1 LBT duration 353 corresponding to a CAPC priority for a transmission on the candidate resource 352, the terminal device 120-1 may determine that there is no overlapping between the reserved resource 351 and a type-1 LBT duration related to the candidate resource 352. Since the gap between the candidate resource 362 and the subsequent reserved resource 361 is equal to or larger than the typical type-1 LBT duration 363 corresponding to a CAPC priority for a transmission on the reserved resource 361, the terminal device 120-1 may determine that there is no overlapping between the candidate resource 362 and a type-1 LBT duration related to the reserved resource 361.

FIG. 4 illustrates a flowchart of an example method 400 for resource selection in accordance with some embodiments of the present disclosure. In some embodiments, the method 400 can be implemented at a device in a communication network, such as the terminal device 120-1 as shown in FIG. 1. Additionally or alternatively, the method 400 can be implemented at other devices shown in FIG. 1. In some other embodiments, the method 400 may be implemented at devices not shown in FIG. 1. Further, it is to be understood that the method 400 may include additional blocks not shown and/or may omit some blocks as shown, and the scope of the present disclosure is not limited in this regard. For the purpose of discussion, the method 400 will be described from the perspective of the terminal device 120-1 with reference to FIG. 1.

At block 410, the terminal device 120-1 reselects at least one slot in an unlicensed band in the case that a LBT procedure fails for a MCSt comprising one or more transmissions of a MAC PDU. At block 420, the terminal device 120-1 retransmits at least one of one or more transmissions in the at least one slot. In this way, a resource (re) selection for a MCSt transmission may be triggered and the reliability of the MCSt transmission may be improved.

Hereinafter, some embodiments of the sidelink resource (re) selection for a MCSt transmission will be described in detail below with reference to FIGS. 5A-5B. FIGS. 5A-5B illustrate examples of resource (re) selection schemes for a MCSt transmission in accordance with some embodiments of the present disclosure. For the purpose of discussion, the resource distributions in FIGS. 5A-5B will be described with reference to FIGS. 1 and 2.

In some embodiments, the reselection may be triggered for the MCSt if LBT procedures fail for all of the one or more transmissions that are associated with the same MAC PDU. In some embodiments, the at least one slot may comprise multiple consecutive slots. For example, the terminal device 120-1 may perform a MCSt transmission in an unlicensed band. A type-1 LBT procedure may be performed prior to the MCSt transmission. If the LBT procedure is failed prior to the first slot, the first slot will be dropped, and the LBT procedure continues to be performed. If the LBT procedure is failed again before the second slot, the second slot will be dropped. Such behavior would continue until the LBT procedure successes, or the LBT procedures fail for all slots of MCSt transmission. In some embodiments, the resource (re) selection may be triggered when a LBT procedure is failed for the last slot of transmissions for the same MAC PDU. Resources of consecutive slots may be selected for all the MAC PDU transmissions in the MCSt transmission.

FIG. 5A illustrates an example of a resource (re) selection 500-1 for a MCSt transmission in accordance with some embodiments of the present disclosure. As shown in FIG. 5A, slots Tx #1~Tx #3 are for the first MAC PDU transmission and slots Tx #4~Tx #5 are for the second MAC PDU transmission. The terminal device 120-1 may trigger a resource (re) selection if LBT procedures 501, 502 and 503 are failed for all the slots Tx #1~Tx #3 for the first MAC PDU transmission. In other words, when the LBT procedure 503 prior to the last slot Tx #3 is failed, a resource (re) selection may be triggered. In some embodiments, resources for consecutive slots (e.g. ReTx #1~ReTx #3) for the first MAC PDU transmission may be reselected during the resource (re) selection.

In some embodiments, the reselection may be triggered for the at least one transmission if at least one LBT procedure fails for the at least one transmission and a LBT procedure succeeds for at least one remaining transmission of the MCSt. The one or more transmissions may be associated with different MAC PDUs. In some embodiments, the at least one slot may comprise multiple consecutive slots. In other words, the resource (re) selection may be triggered when a LBT procedure only succeeds for a portion of the slots for the MCSt transmission for different MAC PDU transmissions. Resources of consecutive slots may be selected for the dropped MAC PDU transmission.

FIG. 5B illustrates an example of another resource (re) selection 500-2 for a MCSt transmission in accordance with some embodiments of the present disclosure. As shown in FIG. 5B, slots Tx #1~Tx #4 are for the first, second, third and fourth MAC PDU transmissions, respectively. The terminal device 120-1 may trigger a resource (re) selection if LBT procedure 503 succeeds for the slot Tx #3 while LBT procedures 501 and 502 are failed for the slots Tx #1~Tx #2. In other words, when a LBT procedure 503 succeeds for MCSt transmission while at least one slot is dropped due to LBT failure, a resource (re) selection may be triggered. In some embodiments, resources for consecutive slots (e.g. ReTx #1~ReTx #2) for the first and second MAC PDU transmissions may be reselected during the resource (re) selection.

### Example Apparatus

FIG. 6 illustrates a simplified block diagram of a device 600 that is suitable for implementing embodiments of the present disclosure. The device 600 can be considered as a further example implementation of the terminal device 120, and the network device 110 as shown in FIG. 1. Accordingly, the device 600 can be implemented at or as at least a part of the network device 110.

As shown, the device 600 includes a processor 610, a memory 620 coupled to the processor 610, a suitable transmitter (TX) and receiver (RX) 640 coupled to the processor 610, and a communication interface coupled to the TX/RX 640. The memory 610 stores at least a part of a program 630. The TX/RX 640 is for bidirectional communications. The TX/RX 640 has at least one antenna to facilitate communication, though in practice an Access Node mentioned in this disclosure may have several ones. The communication interface may represent any interface that is necessary for communication with other network elements, such as X2 interface for bidirectional communications between eNBs or gNBs, S1 interface for communication between a Mobility Management Entity (MME)/Serving Gateway (S-GW) and the eNB or gNB, Un interface for communication between the eNB or gNB and a relay node (RN), or Uu interface for communication between the eNB or gNB and a terminal device.

The program 630 is assumed to include program instructions that, when executed by the associated processor 610, enable the device 600 to operate in accordance with the embodiments of the present disclosure, as discussed herein with reference to FIGS. 1-6. The embodiments herein may be implemented by computer software executable by the processor 610 of the device 600, or by hardware, or by a combination of software and hardware. The processor 610 may be configured to implement various embodiments of the present disclosure. Furthermore, a combination of the processor 610 and memory 620 may form processing means 650 adapted to implement various embodiments of the present disclosure.

The memory 620 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 620 is shown in the device 600, there may be several physically distinct memory modules in the device 600. The processor 610 may be of any type suitable to the local technical network, and may include one or more of general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

In some embodiments, an apparatus capable of performing the methods 200 or 400 (for example, the terminal device 120-1) may comprise means for performing the respective steps of the methods 200 or 400. The means may be implemented in any suitable form. For example, the means may be implemented in a circuitry or software module. In some embodiments, the means comprises at least one processor and at least one memory including computer program code, the at least one memory and computer program code configured to, with the at least one processor, cause the performance of the methods 200 or 400.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

The embodiments of the present disclosure may further be described using the following clauses.
Clause 1. A terminal device comprising: a processor; and a transceiver coupled to the processor, wherein the processor is configured to: trigger a sidelink resource selection for a sidelink transmission in an unlicensed band, wherein a listen before talk (LBT) procedure is to be performed prior to the sidelink transmission; and perform the sidelink resource selection based on a condition associated with at least one resource reserved by the terminal device.
Clause 2. The terminal device of clause 1, wherein performing the sidelink resource selection comprises avoiding selecting the candidate resource for the sidelink transmission based on: a type-1 LBT duration related to a candidate resource being overlapped with one of the at least one reserved resource in time domain; or a type-1 LBT duration related to one of the at least one reserved resource being overlapped with the candidate resource in time domain.
Clause 3. The terminal device of clause 1, wherein performing the sidelink resource selection comprises avoiding selecting the candidate resource for the sidelink transmission based on one of the following:
the candidate resource and the reserved resource being consecutive resources in time domain but with different channel access priority class (CAPC) priorities for transmissions on the candidate resource and the reserved resource;
the candidate resource and the reserved resource being consecutive resources in time domain but with different CAPC priorities for transmissions on the candidate resource and the reserved resource, a transmission priority for transmission on one of the consecutive resources with a higher CAPC priority being higher than a threshold priority;
the candidate resource and the reserved resource being consecutive resources in time domain but with different CAPC priorities for transmissions on the candidate resource and the reserved resource, a transmission priority for transmission on one of the consecutive resources with a higher CAPC priority being configured such that a CAPC priority cannot be decreased for the transmission priority;
the candidate resource being subsequent to the reserved resource and in an expected channel occupancy time (COT) duration related to the reserved resource, and a CAPC priority for transmission on the candidate resource being lower than that on the reserved resource; or
the reserved resource being subsequent to the candidate resource and in an expected COT duration related to the candidate resource, and a CAPC priority for transmission on the reserved resource being lower than that on the candidate resource.
Clause 4. The terminal device of clause 1, wherein performing the sidelink resource selection comprises avoiding selecting a candidate resource for the sidelink transmission based on one of the following:
the sidelink transmission being a wideband transmission for which multiple LBT procedures are to be performed on multiple resource block (RB) sets in the candidate resource, and at least one of the multiple LBT procedures being overlapped with the at least one reserved resource; or
a transmission on one of the at least one reserved resource being a wideband transmission for which multiple LBT procedures are to be performed on multiple RB sets in the reserved resource, and at least one of the multiple LBT procedures being overlapped with the candidate resource.
Clause 5. The terminal device of clause 1, wherein the sidelink transmission is included in multiple medium access control protocol data unit (MAC PDU) transmissions, and wherein performing the sidelink resource selection comprises one of the following:
avoiding selecting a series of candidate resources for the multiple MAC PDU transmissions in the case that at least one candidate resource of the series of candidate resources is overlapped with a type-1 LBT duration related to the at least one reserved resource; or
avoiding selecting a series of candidate resources for the multiple MAC PDU transmissions in the case that a type-1 LBT duration related to at least one candidate resource of the series of candidate resources is overlapped with the at least one reserved resource.
Clause 6. The terminal device of clause 1, wherein the sidelink transmission is included in multiple MAC PDU transmissions, and wherein performing the sidelink resource selection comprises avoiding selecting a candidate resource among a series of candidate resources for the multiple MAC PDU transmissions based on one of the following:
the candidate resource being overlapped with a type-1 LBT duration related to the at least one reserved resource; or
a type-1 LBT duration related to the candidate resource being overlapped with the at least one reserved resource.
Clause 7. The terminal device of clause 1, wherein performing the sidelink resource selection comprises determining a candidate resource as selectable for the sidelink transmission based on one of the following:
a type-1 LBT duration related to the candidate resource being not overlapped with the at least one reserved resource in time domain, and the candidate resource being not overlapped with type-1 LBT durations related to the at least one reserved resource in time domain;
a type-2 LBT procedure being to be performed for transmission on the candidate resource which is subsequent to one of the at least one reserved resource in time domain; or
a type-2 LBT procedure being to be performed for transmission on one of the at least one reserved resource which is subsequent to the candidate resource in time domain.
Clause 8. The terminal device of clause 1, wherein a type-1 LBT duration related to a candidate resource is overlapped with one of the at least one reserved resource in time domain or a type-1 LBT duration related to one of the at least one reserved resource is overlapped with the candidate resource in time domain, and wherein performing the sidelink resource selection comprises determining the candidate resource as selectable for the sidelink transmission based on one of the following:
the candidate resource and the reserved resource being consecutive resources in time domain;
the candidate resource and the reserved resource being consecutive resources in time domain but with the same CAPC priority for transmissions on the candidate resource and the reserved resource;
the candidate resource and the reserved resource being consecutive resources in time domain but with different CAPC priorities for transmissions on the candidate resource and the reserved resource, a transmission priority for transmission on one of the consecutive resources with a higher CAPC priority being lower than a threshold priority;
the candidate resource and the reserved resource being consecutive resources in time domain but with different CAPC priorities for transmissions on the candidate resource and the reserved resource, a transmission priority for transmission on one of the consecutive resources with a higher CAPC priority being configured such that a CAPC priority can be decreased for the transmission priority;
the candidate resource being subsequent to the reserved resource and in an expected COT duration related to the reserved resource, and a CAPC priority for transmission on the candidate resource being higher than that on the reserved resource;
the reserved resource being subsequent to the candidate resource and in an expected COT duration related to the candidate resource, and a CAPC priority for transmission on the reserved resource being higher than that on the candidate resource;
the candidate resource being subsequent to the reserved resource and in a shared COT duration related to the reserved resource, and a transmission on the candidate resource fulfilling a condition to utilize the shared COT duration; or
the reserved resource being subsequent to the candidate resource and in in a shared COT duration for transmission on the candidate resource, and a transmission on the reserved resource fulfilling a condition to utilize the shared COT duration.
Clause 9. The terminal device of clause 3 or 8, wherein the transmission priority is one of the following: a CAPC priority; a traffic priority; a logical channel priority; or a MAC PDU priority.
Clause 10. The terminal device of clause 1, wherein performing the sidelink resource selection comprises: determining a candidate resource as selectable for the sidelink transmission in the case that a gap length between the candidate resource and the at least one reserved resource is no smaller than a predetermined type-1 LBT duration length for transmission on the candidate resource or the at least one reserved resource.
Clause 11. The terminal device of clause 10, wherein the predetermined type-1 LBT duration length is one of the following: configured or preconfigured for a CAPC priority; specified by a standard for a CAPC priority; or indicated by a physical layer of the terminal device for a CAPC priority.
Clause 12. A terminal device comprising: a processor; and a transceiver coupled to the processor, wherein the processor is configured to: reselect at least one slot in an unlicensed band in the case that a listen before talk (LBT) procedure fails for a multi-consecutive slots transmission (MCSt) comprising one or more transmissions of a medium access control protocol data unit (MAC PDU); and retransmit at least one of one or more transmissions in the at least one slot.
Clause 13. The terminal device of clause 12, wherein the reselection is triggered for the MCSt if LBT procedures fail for all of the one or more transmissions that are associated with the same MAC PDU.
Clause 14. The terminal device of clause 12, wherein the reselection is triggered for the at least one transmission if at least one LBT procedure fails for the at least one transmission and a LBT procedure succeeds for at least one remaining transmission of the MCSt, the one or more transmissions being associated with different MAC PDUs.
Clause 15. The terminal device of any of clauses 12-14, wherein the at least one slot comprises multiple consecutive slots.
Clause 16. A method performed by a terminal device, comprising: triggering a sidelink resource selection for a sidelink transmission in an unlicensed band, wherein a listen before talk (LBT) procedure is to be performed prior to the sidelink transmission; and performing the sidelink resource selection based on a condition associated with at least one resource reserved by the terminal device.
Clause 17. A method performed by a terminal device, comprising: reselecting at least one slot in an unlicensed band in the case that a listen before talk (LBT) procedure fails for a multi-consecutive slots transmission (MCSt) comprising one or more transmissions of a medium access control protocol data unit (MAC PDU); and retransmitting at least one of one or more transmissions in the at least one slot.
Clause 18. A non-transitory computer readable medium having program instructions stored thereon that, when executed by an apparatus, cause the apparatus at least to: trigger a sidelink resource selection for a sidelink transmission in an unlicensed band, wherein a listen before talk (LBT) procedure is to be performed prior to the sidelink transmission; and perform the sidelink resource selection based on a condition associated with at least one resource reserved by the terminal device.
Clause 19. A non-transitory computer readable medium having program instructions stored thereon that, when executed by an apparatus, cause the apparatus at least to: reselect at least one slot in an unlicensed band in the case that a listen before talk (LBT) procedure fails for a multi-consecutive slots transmission (MCSt) comprising one or more transmissions of a medium access control protocol data unit (MAC PDU); and retransmit at least one of one or more transmissions in the at least one slot.

1. A terminal device comprising:
at least one memory; and
at least one processor coupled with the at least one memory and configured to cause the terminal device to:
trigger a sidelink resource selection for a sidelink transmission in an unlicensed band, wherein a listen before talk (LBT) procedure is to be performed prior to the sidelink transmission; and
perform the sidelink resource selection based on a condition associated with at least one resource reserved by the terminal device.

2. The terminal device of claim 1, wherein performing the sidelink resource selection comprises avoiding selecting a candidate resource for the sidelink transmission based on:
a type-1 LBT duration related to the candidate resource overlapping in a time domain with one of the at least one resources reserved by the terminal device; or
a type-1 LBT duration related to one of the at least one resources reserved by the terminal device overlapping with the candidate resource in the time domain.

3. The terminal device of claim 1, wherein performing the sidelink resource selection comprises avoiding selecting a candidate resource for the sidelink transmission based on one of the following:
the candidate resource and the at least one resource reserved by the terminal device being consecutive resources in a time domain but with different channel access priority class (CAPC) priorities for transmissions on the candidate resource and the at least one resource reserved by the terminal device;
the candidate resource and the at least one resource reserved by the terminal device being consecutive resources in the time domain but with different CAPC priorities for transmissions on the candidate resource and the at least one resource reserved by the terminal device, a transmission priority for transmission on one of the consecutive resources with a higher CAPC priority being higher than a threshold priority;
the candidate resource and the at least one resource reserved by the terminal device being consecutive resources in the time domain but with different CAPC priorities for transmissions on the candidate resource and the at least one resource reserved by the terminal device, a transmission priority for transmission on one of the consecutive resources with a higher CAPC priority being configured such that a CAPC priority cannot be decreased for the transmission priority;
the candidate resource being subsequent to the at least one resource reserved by the terminal device and in an expected channel occupancy time (COT) duration related to the at least one resource reserved by the terminal device, and a CAPC priority for transmission on the candidate resource being lower than that on the at least one resource reserved by the terminal device; or
the at least one resource reserved by the terminal device being subsequent to the candidate resource and in an expected COT duration related to the candidate resource, and a CAPC priority for transmission on the at least one resource reserved by the terminal device being lower than that on the candidate resource.

4. The terminal device of claim 1, wherein performing the sidelink resource selection comprises avoiding selecting a candidate resource for the sidelink transmission based on one of the following:
the sidelink transmission being a wideband transmission for which multiple LBT procedures are to be performed on multiple resource block (RB) sets in the candidate resource, and at least one of the multiple LBT procedures overlapping with the at least one resource reserved by the terminal device; or
a transmission on one of the at least one resources reserved by the terminal device being a wideband transmission for which multiple LBT procedures are to be performed on multiple RB sets in the at least one resource reserved by the terminal device, and at least one of the multiple LBT procedures overlapping with the candidate resource.

5. The terminal device of claim 1, wherein the sidelink transmission is included in multiple medium access control protocol data unit (MAC PDU) transmissions, and wherein performing the sidelink resource selection comprises one of the following:
avoiding selecting a series of candidate resources for the multiple MAC PDU transmissions in response to at least one candidate resource of the series of candidate resources overlapping with a type-1 LBT duration related to the at least one resource reserved by the terminal device; or
avoiding selecting a series of candidate resources for the multiple MAC PDU transmissions response to a type-1 LBT duration related to at least one candidate resource of the series of candidate resources overlapping with the at least one resource reserved by the terminal device.

6. The terminal device of claim 1, wherein the sidelink transmission is included in multiple MAC PDU transmissions, and wherein performing the sidelink resource selection comprises avoiding selecting a candidate resource among a series of candidate resources for the multiple MAC PDU transmissions based on one of the following:
the candidate resource overlapping with a type-1 LBT duration related to the at least one resource reserved by the terminal device; or
a type-1 LBT duration related to the candidate resource overlapping with the at least one resource reserved by the terminal device.

7. The terminal device of claim 1, wherein performing the sidelink resource selection comprises determining a candidate resource is selectable for the sidelink transmission based on one of the following:
a type-1 LBT duration related to the candidate resource not overlapping with the at least one resource reserved by the terminal device in a time domain, and the candidate resource not overlapping with type-1 LBT durations related to the at least one resource reserved by the terminal device in the time domain;
a type-2 LBT procedure to be performed for transmission on the candidate resource that is subsequent to one of the at least one resources reserved by the terminal device in the time domain; or
a type-2 LBT procedure to be performed for transmission on one of the at least one resources reserved by the terminal device that is subsequent to the candidate resource in the time domain.

8. The terminal device of claim 1, wherein a type-1 LBT duration related to a candidate resource overlaps with one of the at least one resources reserved by the terminal device in a time domain or a type-1 LBT duration related to one of the at least one resources reserved by the terminal device overlapping with the candidate resource in the time domain, and
wherein performing the sidelink resource selection comprises determining the candidate resource is selectable for the sidelink transmission based on one of the following:
the candidate resource and the at least one resource reserved by the terminal device being consecutive resources in the time domain;
the candidate resource and the at least one resource reserved by the terminal device being consecutive resources in the time domain but with the same CAPC priority for transmissions on the candidate resource and the at least one resource reserved by the terminal device;
the candidate resource and the at least one resource reserved by the terminal device being consecutive resources in the time domain but with different CAPC priorities for transmissions on the candidate resource and the at least one resource reserved by the terminal device, a transmission priority for transmission on one of the consecutive resources with a higher CAPC priority being lower than a threshold priority;
the candidate resource and the at least one resource reserved by the terminal device being consecutive resources in the time domain but with different CAPC priorities for transmissions on the candidate resource and the at least one resource reserved by the terminal device, a transmission priority for transmission on one of the consecutive resources with a higher CAPC priority being configured such that a CAPC priority can be decreased for the transmission priority;
the candidate resource being subsequent to the at least one resource reserved by the terminal device and in an expected COT duration related to the at least one resource reserved by the terminal device, and a CAPC priority for transmission on the candidate resource being higher than that on the at least one resource reserved by the terminal device;
the at least one resource reserved by the terminal device being subsequent to the candidate resource and in an expected COT duration related to the candidate resource, and a CAPC priority for transmission on the at least one resource reserved by the terminal device being higher than that on the candidate resource;
the candidate resource being subsequent to the at least one resource reserved by the terminal device and in a shared COT duration related to the at least one resource reserved by the terminal device, and a transmission on the candidate resource fulfilling a condition to utilize the shared COT duration; or
the at least one resource reserved by the terminal device being subsequent to the candidate resource and in in a shared COT duration for transmission on the candidate resource, and a transmission on the at least one resource reserved by the terminal device fulfilling a condition to utilize the shared COT duration.

9. The terminal device of claim 8, wherein the transmission priority comprises one of:
a CAPC priority;
a traffic priority;
a logical channel priority; or
a medium access control protocol data unit (MAC PDU) priority.

10. The terminal device of claim 1, wherein performing the sidelink resource selection comprises:
determining a candidate resource as selectable for the sidelink transmission in response to a gap length between the candidate resource and the at least one resource reserved by the terminal device being no smaller than a predetermined type-1 LBT duration length for transmission on the candidate resource or the at least one resource reserved by the terminal device.

11. The terminal device of claim 10, wherein the predetermined type-1 LBT duration length one of:
configured or preconfigured for a CAPC priority;
specified by a standard for a CAPC priority; or
indicated by a physical layer of the terminal device for a CAPC priority.

12. A terminal device comprising:
at least one memory; and
at least one processor coupled with the at least one memory and configured to cause the terminal device to;
reselect at least one slot in an unlicensed band in response to a listen before talk (LBT) procedure failing for a multi-consecutive slots transmission (MCSt) comprising one or more transmissions of a medium access control protocol data unit (MAC PDU); and
retransmit at least one of one or more transmissions in the at least one slot.

13. The terminal device of claim 12, wherein the reselection is triggered for the MCSt in response to the LBT procedure failing for one or more transmissions that are associated with the same MAC PDU.

14. The terminal device of claim 12, wherein the reselection is triggered for the at least one of the one or more transmissions in response to at least one LBT procedure failing for the at least one of the one or more transmissions and an LBT procedure succeeding for at least one remaining transmission of the MCSt, the one or more transmissions associated with different MAC PDUs.

15. The terminal device of any of claim 12, wherein the at least one slot comprises multiple consecutive slots.

16. A method, comprising:
triggering a sidelink resource selection for a sidelink transmission in an unlicensed band, wherein a listen before talk (LBT) procedure is to be performed prior to the sidelink transmission; and
performing the sidelink resource selection based on a condition associated with at least one reserved resource.

17. The method of claim 16, wherein performing the sidelink resource selection comprises avoiding selecting a candidate resource for the sidelink transmission based on:
a type-1 LBT duration related to the candidate resource overlapping in a time domain with one of the at least one reserved resources; or
a type-1 LBT duration related to one of the at least one reserved resources overlapping with the candidate resource in the time domain.

18. The method of claim 16, wherein performing the sidelink resource selection comprises avoiding selecting a candidate resource for the sidelink transmission based on one of the following:
the candidate resource and the at least one reserved resource being consecutive resources in a time domain but with different channel access priority class (CAPC) priorities for transmissions on the candidate resource and the at least one reserved resource;
the candidate resource and the at least one reserved resource being consecutive resources in the time domain but with different CAPC priorities for transmissions on the candidate resource and the at least one reserved resource, a transmission priority for transmission on one of the consecutive resources with a higher CAPC priority being higher than a threshold priority;
the candidate resource and the at least one reserved resource being consecutive resources in the time domain but with different CAPC priorities for transmissions on the candidate resource and the at least one reserved resource, a transmission priority for transmission on one of the consecutive resources with a higher CAPC priority being configured such that a CAPC priority cannot be decreased for the transmission priority;
the candidate resource being subsequent to the at least one reserved resource and in an expected channel occupancy time (COT) duration related to the at least one reserved resource, and a CAPC priority for transmission on the candidate resource being lower than that on the at least one reserved resource; or
the at least one reserved resource being subsequent to the candidate resource and in an expected COT duration related to the candidate resource, and a CAPC priority for transmission on the at least one reserved resource being lower than that on the candidate resource.

19. A method, comprising:
reselecting at least one slot in an unlicensed band in response to a listen before talk (LBT) procedure failing for a multi-consecutive slots transmission (MCSt) comprising one or more transmissions of a medium access control protocol data unit (MAC PDU); and
retransmitting at least one of one or more transmissions in the at least one slot.

20. The method of claim 19, wherein the reselection is triggered for the MCSt in response to the LBT procedure failing for one or more transmissions that are associated with the same MAC PDU.
